(19) United States
(12) Patent Application Publication
(10) Pub. No.: US 2018/0136678 A1
(43) Pub. Date: May 17, 2018

(54) METHOD OF OPERATING A MULTI-PHASE DC-DC CONVERTER

(71) Applicant: HELLA GmbH & Co. KGaA, Lippstadt (DE)

(72) Inventors: Steffen BOLZENIUS, Meschede (DE); Christian BUHLHELLER, Lippstadt (DE); Andreas DICK, Guetersloh (DE); Michael LOENNEKER, Paderborn (DE); Michael SCHAEFER, Hamm (DE); Juris TLATLIK, Bielefeld (DE)

(73) Assignee: HELLA GmbH & Co. KGaA, Lippstadt (DE)

(21) Appl. No.: 15/816,539

(22) Filed: Nov. 17, 2017

(30) Foreign Application Priority Data
Nov. 17, 2016 (DE) 10 2016 122 089.2

(51) Int. Cl. G05F 1/46; H02M 3/16

(52) U.S. Cl. CPC G05F 1/462; H02M 3/16

(57) ABSTRACT

A method for balancing in a multi-phase DC-DC converter, wherein at least two cells are provided, in each of which at least two phases of the DC-DC converter are grouped, wherein an operation of the individual cells is correlated with respective cell operating values, and an operation of the individual phases is correlated with respective phase operating values, and for balancing, an at least two-stage regulation is carried out with the steps: modulating the phase operating values of the phases as per a first regulation so that the phase operating values are modulated within the cell, and/or modulating the cell operating values of the cells as per a second regulation such that the cell operating values are modulated among themselves.

This nonprovisional application claims priority under 35 U.S.C. § 119(a) to German Patent Application No. 10 2016 122 089.2, which was filed in Germany on Nov. 17, 2016, and which is herein incorporated by reference.

### BACKGROUND OF THE INVENTION

### Field of the Invention

The present invention relates to a method for operating, in particular for balancing, in a multi-phase DC-DC converter. Furthermore, the invention relates to a DC-DC converter.

### Description of the Background Art

It is known from the prior art to use multiphase DC-DC converters in which load balancing is made possible by using multiple phases for the power transfer.

However, when loaded, due to different causes, uneven balancing of the load among the individual phases may occur. For example, hardware tolerances, activation or the like may lead to such an asymmetrical balancing of the load among the individual phases. It may also be possible that due to an internal defect in the DC-DC converter, the phases of the DC-DC converter fail.

Here, it is particularly disadvantageous that differing deterioration of the phases is possible, possibly causing an overload in the individual phases. Accordingly, the asymmetrical load balancing can lead to component damage and/or to a reduction in the service life. Further, it is particularly disadvantageous that due to the internal defects, the operation of the DC-DC converter is restricted or impeded. In particular, it may result in damage to the power stage, so that a power transfer by means of the DC-DC converter is no longer sufficiently achieved.

### SUMMARY OF THE INVENTION

It is therefore an object of the present invention to at least partially overcome the disadvantages described above. In particular, it is an object of the present invention to improve the operation of the DC-DC converter, and to increase the availability. In particular, rapid and/or reliable balancing in a multi-phase DC-DC converter is to be provided.

In this case, features and details that are described in respect of the method according to the invention, of course, also apply in respect of the DC-DC converter according to the invention, and in each case vice versa, so that with respect to the disclosure, mutual reference is or may be made to the individual aspects of the invention.

The object is in particular achieved by a method for operating, in particular for balancing, in a multi-phase DC-DC converter.

It is possible that at least (or exactly or exclusively) two cells are provided, in each of which at least two (or at least three) phases of the DC-DC converter are grouped. In other words, the phases of the DC-DC converter are grouped into cells so that each of these cells comprise at least two (or three) of the phases. For example, the individual cells may each be regarded as a functional grouping of associated phases. Such phases of the DC-DC converter can be grouped in a common cell, which are functionally correlated with one another, For example, interdependent.

In particular, it is conceivable that in each of the cells, a cell operating value, particularly an (output) current value of the respective cell, and that in each of the phases, a phase operating value, particularly an (output) current value of the respective phase, are correlated with the respective operation, in particular in that the cell or phase operating values are influenced by the particular operation. In other words, the cells operating values respectively are correlated with an operation of the individual cells, in particular, depend on it. The phase operating values in each case are, for example, correlated with an operation of the individual phases, in particular, depend on it. For example, the cell operating values and/or phase operating values can also be measured in order to control regulation, in particular in the context of a control loop. Of course, it is also possible to do without a calculation of the cell and/or phase operating values.

For example, an at least two-stage regulation takes place for the (current) balancing, for which purpose at least one of the following steps is performed, for example cyclically, wherein the steps can be performed sequentially or in random order, wherein the steps and/or individual steps can also be performed repeatedly: modulating the phase operating values of the phases as per a first regulation, so that the phase operating values are modulated within the cell, in particular by modulating the operation of the phases as a phase balancing, and/or modulating the cell operating values of the cells as per a second regulation so that the cell operating values are modulated among themselves, i.e. in particular spanning all cells, in particular by modulating the operation of the cells as a cell balancing.

This has the advantage that a balancing can be achieved particularly reliably and efficiently by such a multi-stage regulation. It may be possible that initially the first regulation is performed in a first stage, and the second regulation is performed in a second stage, wherein it is understood that, if necessary, further stages may be provided.

The operation of the cells is carried out in particular as a function of clock parameters of a timing of these cells. By specifying the clock parameter, e.g., of a duty cycle, for timing a single cell, an electrical output variable of that cell may particularly be influenced and/or controlled and/or regulated. For example, an operation, in particular the timing, of the cell in the DC-DC converter takes place as a function of the respective timing parameter. In particular, a modulation of the timing parameter for this particular cell is performed to modulate a respective cell operating value, i.e., for example, an electrical output variable of the respective cells.

The operation of the phases takes place in particular as a function of clock parameters, e.g., of a duty cycle, a timing of these phases. By specifying the clock parameter for the timing of a single phase, in particular, an electrical output variable of this phase can be influenced and/or controlled and/or regulated. For example, an operation, in particular the timing, of this phase in the DC-DC converter takes place as a function of the respective timing parameter. The specification of the timing parameters for the phases of a respective cell is effected in particular by means of a cell-specific set value of this cell.

The cells and/or the phases can be operated in a clocked manner, in particular, clocked by a pulse width modulation. In particular, to modulate a respective phase operating value, i.e., for example, of an electrical output variable of the respective phase, a modulation of the clock parameter for this particular phase takes place.

The expression “within the cell” can refer in particular to the fact that the modulation (e.g. to a common phase operating value, which in particular may be an actual value of the phase) is made by taking into account (only) the phases of the respective cell, that is, for example, limited to the single cell, and/or is made without considering or independent of the phases of the other cells. The intracellular modulation thus has in particular the purpose to modulate only the phases in a single cell. The modulation of the cell operating values (e.g., as the actual value of the respective cells), in contrast, takes place for the cells among themselves, i.e., by taking into account the other cells. Thus, in the second stage, a modulation of the cell operating values is achieved, for example, to a common cell operating value in order to allow, e.g., an approximation of the cell operating values to a common set value. On the other hand, in the intracellular modulation an approximation of the phase operating values to a cell-specific set value can take place, which may be different for each of the cells.

The balancing and/or modulation can be carried out only for such phases and/or cells that are active. Depending on a load of the DC-DC converter it may be possible in this case that individual cells are set to inactive. Accordingly, the inactive cells and/or phases are excluded from the modulation, as they preferably do not perform a power transfer.

In particular, during regulation the stages are hierarchically dependent on each other. Thus, the cells are, for example, hierarchically arranged above the phases since in each case several (i.e., at least two) phases are each grouped to form a single cell. It may therefore be possible that the operation of the individual phases of a respective cell is correlated with the respective phase operating values and/or the cell operating value of this respective cell. For example, the operation and/or the phase operating values of the phases of the individual cell influence the cell operating value of this cell and/or vice versa. In this way, the operation of all phases of this cell can be quickly and easily influenced by the modulation of a cell operating value of a respective cell, and/or vice versa.

The balancing can take place in such a way that a uniform loading of the individual phases of the DC-DC converter is sought. For example, the DC-DC converter may be rated for output in a wide power range, for example, to a maximum of 2000 watts (W) or a maximum of 3000 W or a maximum of 4000 W. The DC-DC converter comprises several phases for load balancing, which are arranged in particular in parallel. In this way, the load can be reliably balanced between the phases so that each of the phases is charged, for example, with a maximum of 20 amperes (A) or a maximum of 40 A or a maximum of 50 A or a maximum of 70 A.

The phase outputs of the individual phases can be connected and/or merged via at least one summation point, so that particularly, for example, the phase outputs of the individual phases again merge at the output of the DC-DC converter. An electrical output variable of the DC-DC converter at this output is thus correlated with the electrical output variables of the individual phases at the respective phase outputs. Thus, in particular an electric power transfer takes place via the individual phases, which, in particular, together form the entire power transfer of the DC-DC converter.

In this case, electrical output variable is understood to mean, in particular, an electrical variable, in particular an electrical current and/or an electrical voltage and/or an electrical power.

For example, it is provided that, subject to primary factors, in particular a load of the DC-DC converter or the like, a primary objective for the power transfer is determined. For example, it is determined that (at least or at a maximum or substantially), 90 amperes (A) should be present at the output of the DC-DC converter. The primary objective may, for example, also include a set value. For balancing the load, the primary objective is then balanced between the cells of the DC-DC converter, so that, for example, each cell is to transfer only a share of the primary objective, e.g., only 45 A. This balancing occurs in particular uniformly for all active cells. Subsequently, for example, a further balancing occurs between the phases of the individual (active) cells so that in particular each of these phases is assigned a (in particular identical) share of the share of the respective cell. For example, each of the phases should then transfer 15 A. The balancing is, in particular, realized by the modulation of the cell and/or phase operating values which can take place by means of a modulation of the timing for the individual cells or phases. Uneven development or deviations of the balancing in the operation of the DC-DC converter can be compensated by the (multi-stage) balancing. To this end, in particular a measurement of the phase and/or cell operating values and/or the current in the individual phases is carried out, and a corresponding readjustment. For example, a superimposed current controller then automatically readjusts the total current. This makes it possible to achieve a symmetrical balancing of the load in the DC-DC converter in a simple and cost-effective manner.

For example, it is provided that in each case at least or exactly two phases (or in each case at least or precisely three phases) of the phases of the DC-DC converter are grouped into a common cell. In other words, a plurality of cells are provided in the DC-DC converter, each of which (at least or exactly) comprise two (or three) phases, wherein each of the phases of the DC-DC converter can be allocated (unambiguously) to only a single cell.

For example, one of the (at least two or three) phases of a respective cell forms a fixed reference phase. In other words, each of the cells comprises exactly one reference phase. The reference phase is used for intracellular modulation (in particular intracellular balancing). For example, to this end, the phases of the respective cell are modulated to the respective reference phase so that in particular the phase operating values, in particular the electrical output variables, of the individual phases of the respective cell are modulated to each other (depending on the electrical output variable of the reference phase). This process (i.e., the intracellular modulation) is repeated for the other cells or for their respective phases, in particular independent of each other and/or simultaneously and/or offset in time.

In addition, it may be advantageous in the context of the invention for the second regulation to regulate the modulation of the cell operating values of the cells among themselves by determining a common set value for at least two or all cell operating values, whereby a phase-higher modulation takes place. The common set value is determined, for example, as a function of an operation of the DC-DC converter, in particular a load of the DC-DC converter, and can be calculated by a processing device.

In particular, a modulation of the cell operating values takes place by means of a modulation of the operation of the respective cells in such a way that in each case a common set value is desired, and that the respective cell operating value can approach the common set value as the actual value. Thus, reliable regulation is possible.

It is also conceivable that, for the first regulation for at least one of the cells or each (of the active) cell(s), a respective cell-specific set value for the phase operating values of the phases of the cell is determined, whereby the intracellular modulation of the phase operating values can take place. In this case, the cell-specific set value is can be assigned to the individual respective cell, i.e., in particular to the phases of this cell. In particular, the cell-specific set value is determined based on at least one of the phases of the respective cell, e.g., based on the reference phase of the respective cell. This way, a simple modulation of the phases can be carried out for individual cells, without having to provide cross-cell regulation in this first stage.

In particular, a modulation of the phase operating values occurs by modulating the operation of the respective phase in such a way that a cell-specific set value is sought, and for example, the respective phase operating value can approach the cell-specific set value as the actual value.

It can advantageously be provided within the context of the invention that for the first regulation, the phase operating values of the phases of the respective cell are regulated to a respective cell-specific set value, wherein the set value is determined based on the phases of the respective cell, in particular based on a reference phase of the respective cell, so that a balancing of the phases of the respective cell among themselves can be carried out. In particular, it may be possible that for each cell, one of the phases of this cell serves as the reference phase so as to determine a reference value. Alternatively, it may be possible for the reference value to be determined by performing a calculation based on the phases of the respective cell; in particular, an average of the phases of the respective cell is formed. Accordingly, a reference value per cell is determined based on the phases of the respective cell. The reference value corresponds, for example, to the cell-specific set value. In particular, the reference values for the phases of different cells may differ from each other. The phases of a (common) respective cell can be regulated to the same reference value of this cell so that an identical phase operating value, in particular an identical electrical output variable, for all phases of a (common) respective cell is sought, for example, independent of the phases of other cells.

It is further conceivable that as per the first regulation, the phase operating values of the phases of at least a first cell are regulated to a (common) first cell-specific set value, and that the phase operating values of the phases of at least one second cell can be regulated to a (common) second cell-specific set value, which differs in particular from the first cell-specific set value. For example, as per the second regulation, for the at least first cell and the at least second cell, the respective cell operating values are regulated to an (especially single) common set value (for the active cells), wherein the common set value of the cells is determined in particular on the basis of a load of the DC-DC converter. Therefore, a distinction must be made between the cell-specific set values, which in each case can be set differently for different cells, and the (one) common set value for the cells, which is the same for all active cells. In particular, the common set value serves for the modulation of the cells and the cell-specific set value serves for the modulation of the phases of the respective cell. In other words, as per the first regulation, a phase balancing is carried out, and as per the second regulation, a cell balancing.

It may be possible that the modulation of the phase operating values as per the first regulation includes a modulation of the operation of the phases of the respective cell as a function of a cell-specific set value of the respective cell. Furthermore, it may be possible that the modulation of the cell operating values as per the second regulation includes a modulation of the operation of the cells, subject to a common set value for the cells. The respective set value for the phases and cells may, of course, differ from the respective actual values for the phases and cells, so that, in particular, a corresponding regulation in a control loop can be used here. In other words, in the modulation of the phase operating values as per the first regulation, the operation of the phases of a respective cell can be modulated to the cell-specific set value of the respective cell on the basis of the actual values of the phases. Alternatively or additionally, in the modulation of the cell operating values as per the second regulation, the operation of the cells can be modulated to the common set value for the cells on the basis of the actual values of the cells. These actual values are calculated, for example, by respective (current) measurements, in particular by means of appropriate sensors of the DC-DC converter. In particular, after the second regulation, due to the modulation of the cell operating values, a modulation of the phase operating values of the respective cells also (automatically) takes place on the basis of, or as a function of, the respective cell operating values (e.g., in a subsequent cycle of the first or second regulation) so that a uniform load balancing to the phases takes place. This allows for reliable multi-stage balancing.

It can advantageously be provided in the invention that the phase operating values and cell operating values are specific in each case to an electrical output variable, in particular an (electrical) current or (electrical) voltage or (electrical) power so that in particular, the electrical output variable of each cell is correlated with the electrical output variables of the phases of this cell, and for example, an electrical output variable of the DC-DC converter can be correlated with the electrical output variables of the cells. For example, the phase operating value can be specific to an electrical output variable of a single phase, and the cell operating value can be specific to an electrical output variable of a single cell.

The phase operating value can be an actual value of the electrical output variable of the individual phase, which is measured, for example, for the (first and/or second) regulation and/or compared with the (cell-specific or common) set value. For example, the cell operating value can be an actual value of the electrical output variable of the individual cell, which, for example, is measured for the (first and/or second) regulation and/or is compared with the (cell-specific or common) set value.

Further, it may be provided that the modulation of the phase operating values is effected in that the timing of the phases is regulated phase-specifically, and the modulation of the cell operating values can be achieved in that the timing of the cells is regulated cell-specifically, wherein the timing can be carried out by means of at least one pulse width modulation unit of at least one processing device (of the DC-DC converter). The processing device is advantageously integrated in the DC-DC converter in order to carry out a cost-effective and simple current balancing.

For example, it is conceivable that the balancing is carried out as a current balancing, in particular in a 48 volt (V) DC-DC converter, for example, of a vehicle. In particular, the DC-DC converter serves for the power transfer in at least one electrical system of the vehicle, wherein at least one of the electrical systems is designed as a 48 volt network. In particular, the DC-DC converter is used for the electrical connection of a first electrical system with a second electrical system of the vehicle. The vehicle is designed, for example, as a passenger vehicle, for example, an electric vehicle.

Furthermore, it is optionally possible in the context of the invention that the respective modulation in each case takes place via a PID controller (proportional-integral-derivative controller), which can be provided by a processing device, wherein in particular for purposes of regulation, a current measurement and/or power measurement at the individual phases is carried out by means of the processing device. Of course, it is also conceivable that the modulation is made with other controller types.

Further, it may be possible that in the cells in each case at least three or exactly three phases of the DC-DC converter are grouped. The grouping of the phases into individual cells may be implemented with hardware. In particular, the assignment of the phases to the cells is predetermined by the structure and/or by the interconnection of the electronic components of the DC-DC converter. For example, the operation of the cells and/or phases, i.e., in particular, the balancing, is carried out by a software-based control. This has the advantage that the operation of the DC-DC converter can be modulated very flexibly.

The invention is a DC-DC converter, in particular a multi-phase converter, for the power transfer and/or load transfer, particularly between two networks, for example electrical systems of a vehicle. The vehicle can be designed, for example, as a motor vehicle and/or a passenger vehicle and/or an electric vehicle.

For example, the DC-DC converter is designed multi-phase, for example with at least four phases and/or at least two cells. In particular, at least two (or at least three or exactly three) of the phases of the DC-DC converter are grouped in the cells of the DC-DC converter. For example, the phases of the respective cells differ from one another, wherein the phases and/or all of the phases of different cells can differ from each other. In other words, it may be possible that each of the phases of the DC-DC converter is exclusively assigned to a single cell or is grouped in this cell.

For example, the grouping of the phases in the cells takes place in such a way that the power transfer can be split and/or individually supplied by the (individual) cells. This means in particular that in case of failure of one of the cells, the other cell or the other cells can continue to operate for purposes of the power transfer or load transfer. This drastically increases the reliability and/or availability of the DC-DC converter. Furthermore, the split of the power transfer and/or the individual availability allows for a multi-stage regulation in the DC-DC converter to be possible, and that an efficient balancing can take place. Thus, the DC-DC converter according to the invention involves the same advantages as have already been described in detail with reference to an inventive method. In addition, an inventive DC-DC converter can be operated by means of the inventive method.

In particular, it is provided that in the inventive DC-DC converter, a distribution of the ohmic losses to at least four, for example, 6 phases takes place and/or a distribution of the power stage to the cells of the DC-DC converter, for example, takes place in two power stage cells. This makes it possible in particular, that the power transfer can continue to be provided if the DC-DC converter has internal defects, thus increasing availability. In particular, by means of the distribution and/or by using two cells in the DC-DC converter (i.e., corresponding to two power stage cells), it can be ensured that the DC-DC converter can also be operated at 50% power in case of failure of one of the cells. Furthermore, the multi-phase training DC-DC converter has the advantage that high currents can be transferred, for which purpose electronic components can be used which require only a small amount of space. For example, it may be possible that currents are transferred through the DC-DC converter (in particular on the side of the 12V DC-DC converter).

It is also conceivable that the DC-DC converter comprises at least or exactly six phases, wherein at least or exactly three of the phases of the DC-DC converter (in particular, different phases) can be grouped in each of the cells. This configuration of the DC-DC converter has provided the surprising effect that an optimum power supply and load balancing is made possible, in particular also if an internal defect of one of the cells, in particular power cells, of the DC-DC converter is present.

Optionally, it may be possible that the power transfer in a normal operation of the DC-DC converter can be provided by all cells, in particular power cells, and in an error mode of the DC-DC converter, can be provided by at least one of the cells, wherein in the error mode at least one of the cells is defective. In particular, in this case, an interconnection in the DC-DC converter, in particular the interconnection of the cells with one another, is adapted such that even in the event of failure of a (single) cell, a power transfer via the DC-DC converter can still proceed. This has the advantage of significantly increasing availability.

It may furthermore be advantageous if the phases (of the DC-DC converter) are grouped in the cells uniformly and/or in such a way that in an error mode of the DC-DC converter, the power transfer can be provided at least or substantially at 50%. In other words, it may be possible that each of the cells of the DC-DC converter have an equal number of phases of the DC-DC converter. Thus, safety can be increased during the operation of the DC-DC converter.

Furthermore, it may be possible within the context of the invention that the DC-DC converter is formed as a 48V/12V (V) DC-DC converter, so that the power transfer of a voltage 48V network, in particular a vehicle electrical system, can be converted into a voltage of a 12V network, in particular a vehicle electrical system, and/or vice versa.

Optionally, it may be possible within the scope of the invention that the phases are each designed in a half-bridge topology, and/or form a combination of boost converter and buck converter. Thus, the performance of the DC-DC converter can be further improved.

Further, it may be possible that the cells are each configured as power cells, in particular in each case as a multi-phase power stage of the DC-DC converter, so that the cells, in particular for increasing availability and/or reliability, can independently provide the power transfer to the DC-DC converter. In other words, a power transfer of the DC-DC converter can continue to take place even in the event of failure of one of the cells.

In particular, at least one or each of the phases comprises at least one voltage divider and/or a bridge circuit. For example, it may be possible that the phases of the DC-DC converter in each case are designed as a bridge topology, in particular a half- or full-bridge topology. For example, the phases each comprise at least one electrical component (especially electronics component), for example, at least one resistor element and/or an impedance element and/or a transistor element, for example, a field-effect transistor (FET) and/or a metal oxide semiconductor field effect transistor (MOSFET) and/or a power FET or power MOSFET, which can be interconnected in accordance with the bridge topology. For example, the phases for this purpose each comprise at least one (or two) resistor assemblies and/or a bridge section. Thus, for example, each phase can comprise at least two (or four) electrical components which are interconnected as resistor assemblies. This enables a particularly accurately set power transfer of the phases.

For example, at least one or each of the phases can be designed as a boost converter (or step-up converter) or as a buck converter (or step-down converter), or as a combination of boost converter and buck converter. This is made possible in particular in that each phase has a bridge topology, in particular a half-bridge topology. This allows for a particularly flexible and adaptable regulation of the power transfer and/or load balancing.

Protection is also sought for a DC-DC converter that includes a processing device. It is provided that the processing device is designed for implementing a method according to the invention. Thus, the DC-DC converter according to the invention has the same advantages as have been described in detail with reference to an inventive method.

The invention is explained in more detail below with reference to the accompanying drawings. The features mentioned in the claims and in the description can be essential to the invention individually or in any combination. The drawings show:

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 a schematic representation for visualizing an inventive method and a DC-DC converter according to the invention,

FIG. 2 a further schematic representation for visualizing a method according to the invention,

FIG. 3 a further schematic representation for visualizing a method according to the invention and a DC-DC converter according to the invention,

FIG. 4 a schematic representation for visualizing sections of a DC-DC converter according to the invention.

### DETAILED DESCRIPTION

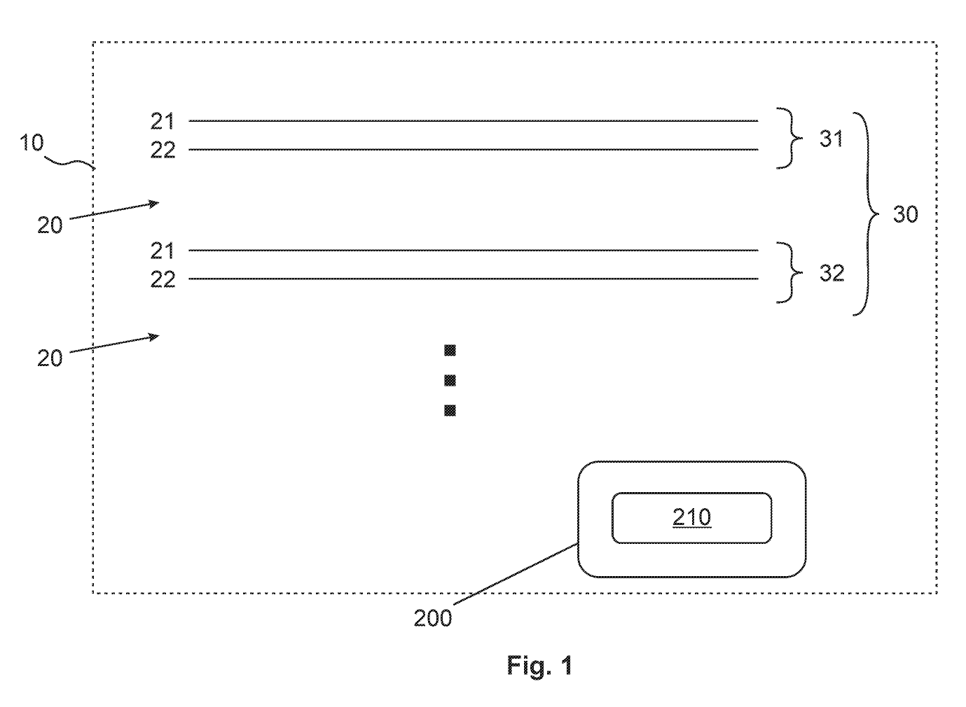

FIG. 1 schematically shows an inventive DC-DC converter 10, which comprises several phases 20. The phases 20 are grouped in cells 30, wherein each of the cells 30 comprises in each case at least two phases 20. Accordingly, a first cell 31 and a second cell 32 are shown, which each comprise a first phase 21 and a second phase 22. A modulation of a cell operating value 430 thereby directly (immediately) influences the single cell 30, and thus indirectly also the phases 20, which are grouped into this cell 30. A modulation of a phase operating value 420, however, affects the individual phases 20 in a direct manner.

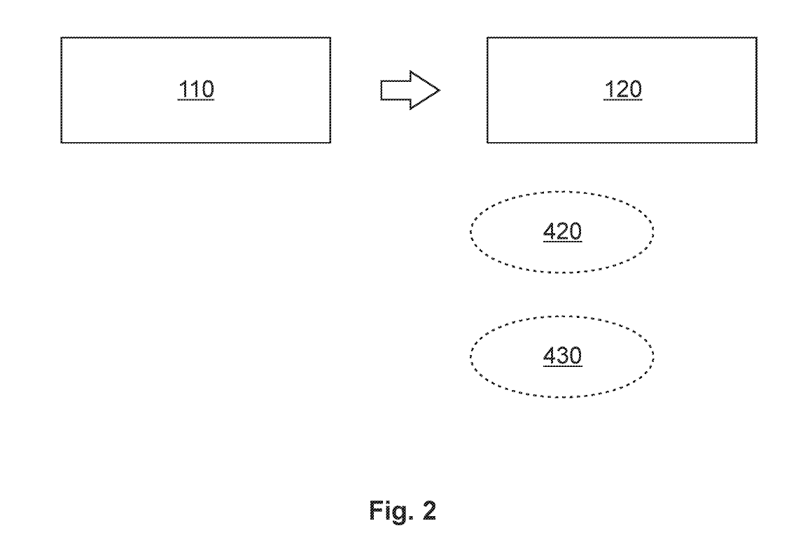

Schematically, the cell operating values 430 and the phase operating values 420 are shown in FIG. 2. Furthermore, it is shown that the cell operating values 430 are modulated by a second regulation 120 and that the phase operating values 420 are modulated by a first regulation 110. The modulation is carried out, for example, by a processing device 200 shown in FIG. 1, in particular by a pulse width modulation unit 210.

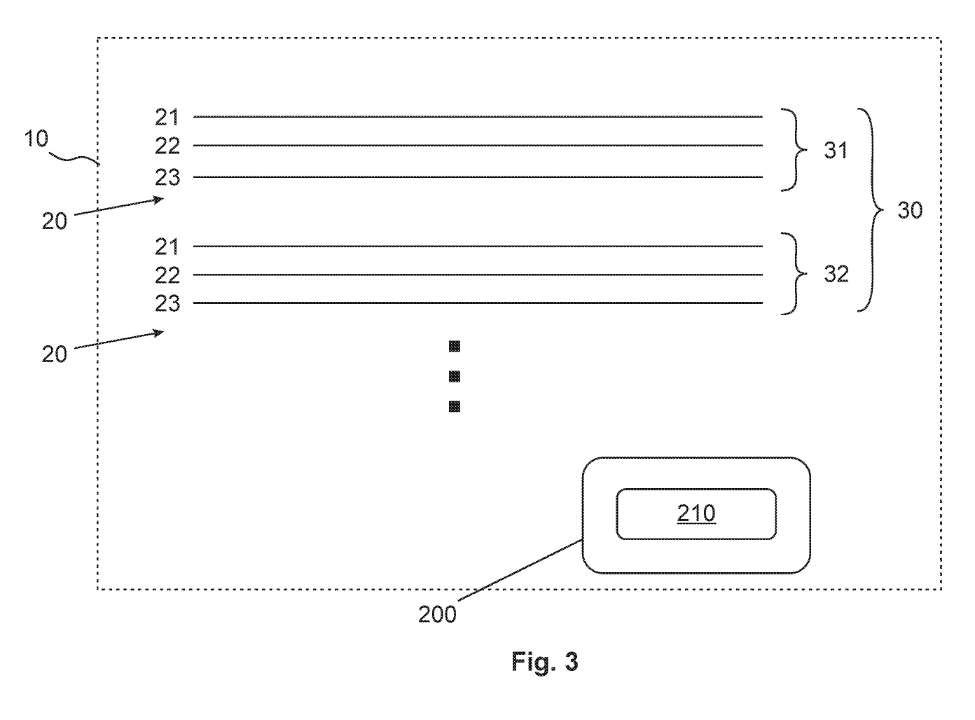

In FIG. 3, an inventive DC-DC converter 10 with (at least) two cells 30 is schematically shown. Each of the cells 30 in this case comprises (at least) three phases 20. In this case, it may be provided that a first phase 21 and second phase 22 and a third phase 23 of the first cell 31 differ from a first phase 21 and a second phase 22 and a third phase 23 of a second cell 32.

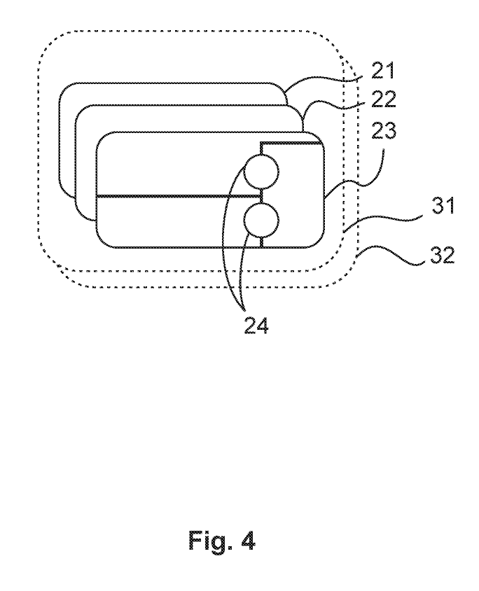

In FIG. 4, a first cell 31 and a second cell 32 are schematically shown, each comprising three phases 21, 22, 23 of the DC-DC converter. Each of the phases 20 can function independently of the other phases 20 for the power transfer and therefore comprises in each case at least one electronic component, for example, a resistor or a transistor element, independent of the other phases 20. It is shown schematically that the electronic component 24 or the respective phase 20 may be designed as a bridge topology, in particular a half-bridge topology. For example, the configuration of the individual phases 20 is configured such that the phases 20 of a first cell 30 can be operated for the power transfer independently of the phases 20 of a second cell 32. This makes it possible in a particularly advantageous manner that due to the respective phases 20, the cells 30 can be used independently of each other for purposes of the power transfer.

The foregoing explanation of the embodiments describes the present invention only in the context of examples. Of course, individual features of the embodiments can be freely combined with each other without departing from the scope of the present invention, provided this is technically useful.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for balancing in a multi-phase DC-DC converter, wherein at least two cells are provided, in each of which at least two phases of the DC-DC converter are grouped, wherein in each cell of the two cells, a cell operating value of the respective cell is correlated with an operation of this cell and in each phase, a phase operating value of the respective phase is correlated with an operation of this phase, and for balancing an at least two-stage regulation the method comprises:
modulating the phase operating values of the phases in accordance with a first regulation so that the phase operating values are modulated within the cell; and
modulating the cell operating values of the cells per a second regulation so that the cell operating values are modulated among themselves.

2. The method according to claim 1, wherein via the second regulation, the modulation of the cell operating values of the cells among themselves is regulated in that a common set value for at least two or all cell operating values is determined, and wherein a primary phase modulation takes place.

3. The method according to claim 1, wherein, for the first regulation, for at least one of the cells or for each cell, a respective cell-specific set value for the phase operating values of the phases of this cell is determined, and wherein the intracellular modulation of the phase operating values takes place.

4. The method according to claim 1, wherein, for the first regulation, the phase operating values of the phases of a respective cell are modulated to a respective cell-specific set value, wherein the set value is determined based on the phases of the respective cell or based on a reference phase of the respective cell.

5. The method according to claim 1, wherein, as per the first regulation, the phase operating values of the phases of at least a first cell are modulated to a first cell-specific set value, and the phase operating values of the phases of at least a second cell are modulated to a second cell-specific set value, which differs from the first cell-specific set value, and wherein, as per the second regulation for the at least first cell and the second cell, the respective cell operating values are modulated to a common set value that is determined on based on a load of the DC-DC converter.

6. The method according to claim 1, wherein the phase operating values and cell operating values are each specific to an electrical output variable or a current or voltage or power so that the electrical output variable of a respective cell is correlated with the electrical output variables of the phases of this cell, and wherein an electrical output variable of the DC-DC converter is correlated with the electrical output variables of the cells.

7. The method according to claim 1, wherein the modulation of the phase operating values occurs in that the timing of the phases is regulated in a phase-specific manner, wherein the modulation of the cell operating values occurs in that a timing of the cells is regulated in a cell-specific manner, and wherein the timing is performed via at least one pulse width modulation unit of at least one processing device.

8. The method according to claim 1, wherein the respective modulation is made in each case by a PID controller which is provided by a processing device.

9. The method according to claim 1, wherein a current measurement and/or power measurement at the individual phases is performed by a processing device for purposes of regulation.

10. The method according to claim 1, wherein, in the cells, in each case at least three or exactly three phases of the DC-DC converter are grouped.

11. A DC-DC converter for a power transfer between two power supplies, which is designed multi-phase, the converter comprising:
at least four phases; and
at least two cells,
wherein in the two cells, at least two of the phases of the DC-DC converter are grouped so that the power transfer is divided among the cells and individually supplied.

12. The DC-DC converter according to claim 11, wherein the DC-DC converter has at least or exactly six phases, wherein, in each of the cells, at least or exactly three of the phases of the DC-DC converter are grouped.

13. The DC-DC converter according to claim 11, wherein the power transfer in a normal operation of the DC-DC converter is supplied by all of the cells, and, in an error mode of the DC-DC converter, are supplied by least one of the cells, and wherein, in the error mode, at least one of the cells is defective.

14. The DC-DC converter according to claim 11, wherein the phases are grouped uniformly in the cells and/or in such that in an error mode of the DC-DC converter, the power transfer are supplied at substantially 50%.

15. The DC-DC converter according to claim 11, wherein the DC-DC converter is a 48 V/12 V DC-DC converter so that via the power transfer, a voltage of a 48 V network is converted into a voltage of a 12 V network, and/or vice versa.

16. The DC-DC converter according to claim 11, wherein the phases are each designed in a half-bridge topology.

17. The DC-DC converter according to claim 11, wherein the cells are power cells or a multi-phase power stage, so that independently of one another, the power transfer for the DC-DC converter is supplied by the cells.

18. The DC-DC converter according to claim 11, further comprising a processing device configured for implementing the method according to claim 1.
